(19) United States
(12) Patent Application Publication
(10) Pub. No.: US 2006/0055915 A1
(43) Pub. Date: Mar. 16, 2006

(54) Measuring apparatus, test reticle, exposure apparatus and device manufacturing method

(76) Inventor: Yoshihiro Shiode, Utsunomiya-shi (JP)

Correspondence Address: MORGAN & FINNEGAN, L.L.P., 3 WORLD FINANCIAL CENTER, NEW YORK, NY, 10281-2101, US

(21) Appl. No.: 11/226,815

(22) Filed: Sep. 13, 2005

(30) Foreign Application Priority Data
Sep. 13, 2004 (JP) 2004-265482

(51) Int. Cl. G01B 9/00

(52) U.S. Cl. 356/124

(57) ABSTRACT

A measuring apparatus for measuring optical characteristic of a target optical system includes plural patterns for reducing diffracted lights except for a predetermined order diffracted light, a collimating part for producing collimated or substantially collimating light, and a condensing part for condensing the collimated or substantially collimated light so that lights having different angles are incident upon the plural patterns, wherein the predetermined order diffracted lights emitted from the plural patterns enter pupil surface in the target optical system at different positions.

### BACKGROUND OF THE INVENTION

The present invention relates generally to a measuring apparatus, and more particularly to a measuring apparatus and a test reticle used to measure a wave front aberration of a projection optical system that transfers a mask or reticle pattern onto a substrate to be exposed. The present invention is also directed to an exposure apparatus and device manufacturing method using the above measuring apparatus and test reticle.

A projection exposure apparatus has conventionally been used to project and transfer a circuit pattern of a photo mask or reticle onto a wafer and the like via a projection optical system in manufacturing semiconductor devices through the photolithography technology. The projection exposure apparatus is required to transfer the reticle pattern onto the wafer precisely at a predetermined magnification or reduction ratio. To meet this requirement, it is important to use a projection optical system having excellent imaging performance and extremely reduced aberration. In particular, due to the recent demands for finer processing to the semiconductor devices, the pattern resolving power is lowered by the aberration that occurs in designing and manufacturing the projection optical system. A fine pattern becomes more sensitive to the aberration of the optical system. Thus, there is a demand to measure the optical characteristic or aberration of the projection optical system with high precision.

A wide variety of aberration measuring method for the projection optical system have currently been proposed, and the actual evaluations and inspections of the projection optical system utilizes measurement results of various types of aberrations, such as a spherical aberration, a curvature of field, an astigmatism, a coma, and a wave front aberration. Among these aberrations, the wave front aberration is a core aberration, and some aberrations, such as the spherical aberration, curvature of field, astigmatism and coma, can be calculated by approximating the wave front aberration using the universally used Zernike polynomial. The importance of the wave-front aberration measurement is emphasized in terms of simulations to predict process margins for a wide variety of patterns.

The wave front aberration of the projection optical system can be measured by utilizing a principle of a Shack-Hartmann method (see, for example, U.S. Pat. Nos. 5,828,455 and 5,978,085).

Another proposed measuring method uses a reticle different from that in the above references to measure the wave front aberration of the projection optical system (see, for example, PCT International Publication No. 03/021352).

The measurement methods disclosed in the above three references commonly use a pinhole, although there is a significant difference between the first two references and the third reference. In the first two references, the pinhole allows only the light along a line that connects each grating pattern to the pinhole, among lights from the illuminated grating pattern. The pinhole blocks the remaining diffracted lights from the grating pattern. The diffracted light from the grating pattern that has passed the pinhole then passes, with a finite diameter, a pupil surface in the projection optical system. The light's diameter on the pupil surface in the projection optical system defines the wave-front detecting resolution. As the diameter becomes smaller, the wave-front detecting resolution becomes finer.

A reduced ratio r/t is necessary for the first two references, where r is a pinhole's diameter, and t is a distance from the grating pattern to the pinhole, so as to reduce a diameter of the light on the pupil surface in the projection optical system. In general, the distance t from the grating pattern to the pinhole cannot be increased due to the specification limits of the exposure apparatus. In addition, as the pinhole diameter reduced, the influence of the diffracted light of the pinhole itself increases and the measuring accuracy of the wave front aberration deteriorates.

On the other hand, the third reference enables the light having a sufficiently large a to pass the pinhole, and illuminate a test pattern with different incident angles. In addition, the test pattern itself restrains its own diffracted light and does not deteriorate the measuring accuracy of the wave front aberration even when the pinhole diameter is small. The reduced pinhole diameter leads to a small light diameter on the pupil surface in the projection optical system, and improves the wave-front detecting resolution.

However, the small pinhole diameter reduces the light intensity disadvantageously. The reduced light intensity deteriorates the accuracy when a CCD measures an aerial image, and delays the exposure or measuring time when the wafer is exposed.

In addition, in a step-and-scan exposure apparatus or so-called scanner, the wave front aberration depends upon the scan speed and the wave front aberration differs according to the scan speeds. Therefore, the wave front aberration should be measured at the same scan speed as that at the actual exposure time. For all of the above references the light intensity is insufficient for a single scan exposure and plural scan exposures are needed. The plural scan exposures delay the measuring time period and deteriorate the measuring accuracy due to the alignment error. In addition, the measured wave front aberration is averaged in the plural scan exposures.

### BRIEF SUMMARY OF THE INVENTION

The present invention is directed to a measuring apparatus and a test reticle, which more accurately and quickly measure the optical characteristic, such as a wave front aberration, of a target optical system. The present invention is also directed to an exposure apparatus and a device manufacturing method utilizing the measuring apparatus and test reticle.

A measuring apparatus according to one aspect of the present invention for measuring optical characteristic of a target optical system includes plural patterns for reducing diffracted lights except for a predetermined order diffracted light, a collimating part for producing collimated or substantially collimating light, and a condensing part for condensing the collimated or substantially collimated light so that lights having different angles are incident upon the plural patterns, wherein the predetermined order diffracted lights emitted from the plural patterns enter pupil surface in the target optical system at different positions.

A test reticle according to another aspect of the present invention used to measure optical characteristic of a target optical system includes plural patterns, formed on one surface, for reducing diffracted lights except for a predetermined order diffracted light, and a condensing part for condensing light so that lights having different angles are incident upon the plural patterns.

An exposure apparatus according to still another aspect of the present invention for exposing a pattern of a reticle onto a substrate includes a projection optical system for projecting the pattern onto the substrate, and the above measuring apparatus for measuring optical characteristic of said projection optical system and/or the above test reticle adapted to be inserted into and ejected from an optical path of said exposure apparatus.

A device manufacturing method according to still another aspect of the present invention includes the steps of exposing a substrate using the above exposure apparatus, and developing the substrate exposed.

Other objects and further features of the present invention will become readily apparent from the following description of the preferred embodiments with reference to accompanying drawings.

### BRIEF DESCRIPTION OF THE DRAWINGS

FIG. 1 is a schematic sectional view showing a measuring apparatus according to one aspect of the present invention.

FIG. 2 is a schematic plane view showing a periodic pattern of a variation of a test reticle shown in FIG. 1.

FIGS. 3A and 3B are schematic plane views of illustrative periodic patterns of the test pattern shown in FIG. 1.

FIG. 4 is a plane view of the details of the test pattern formed on the test reticle shown in FIG. 1.

FIG. 5 is a schematic plane view of an overall test reticle shown in FIG. 1.

FIG. 6 is a plane view showing the details of a reference mark formed on the test reticle shown in FIG. 5.

FIG. 7 is a schematic plane view showing a positional relationship between the test mark and reference mark exposed on a photosensitive substrate.

FIG. 8 is a schematic sectional view of an exposure according to one aspect of the present invention.

FIG. 9 is a flowchart for explaining a method for fabricating devices (semiconductor chips such as ICs, LSIs, and the like, LCDs, CCDs, etc.).

FIG. 10 is a detailed flowchart for Step 4 of wafer process shown in FIG. 12.

FIG. 11 is a schematic sectional view showing a test reticle when a mirror is used for a condensing part.

FIG. 12 is a schematic enlarged view showing a structure of a detector shown in FIG. 1.

FIG. 13 is a graph showing a detection signal detected by a detector shown in FIG. 12.

### DETAILED DESCRIPTION OF THE PREFERRED EMBODIMENTS

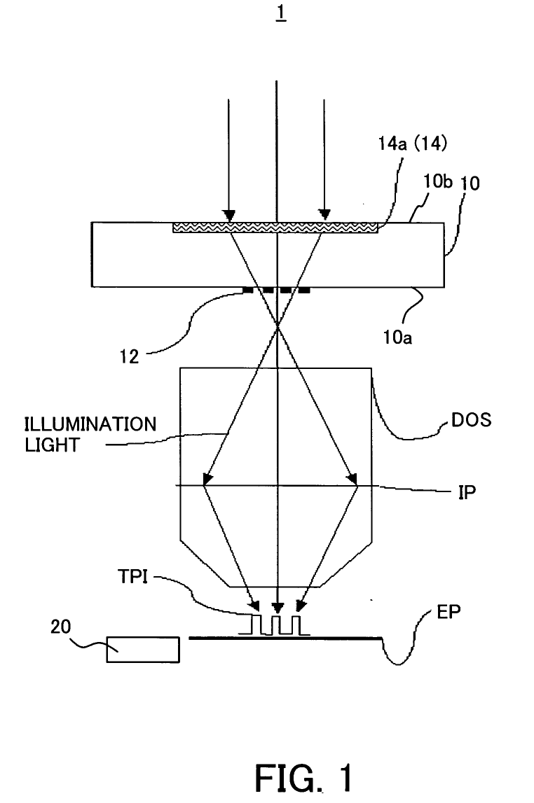

Referring now to the accompanying drawings, a description will be given of a measuring apparatus according to one aspect of the present invention. In each figure, like elements are designated by the same reference numerals, and a duplicate description will be omitted. Here, FIG. 1 is a schematic sectional view showing an inventive measuring apparatus 1. The measuring apparatus 1 includes, as shown in FIG. 1, an illumination optical system (not shown), a test reticle 10, and a detector 20.

The measuring apparatus 1 measures the optical characteristic, such as a wave front aberration, of a target optical system DOS, such as a projection optical system in an exposure apparatus. More specifically, the measuring apparatus 1 measures an aerial image or a pattern image transferred on a photosensitive substrate EP, of a test reticle 10 or a test pattern 12 through the target optical system DOS. The measuring apparatus 1 measures the aberration of the target optical system by measuring a position of the transferred pattern image TPI.

The test reticle 10 includes a test pattern 12 formed on one surface 10a and a condensing part 14 formed on the other surface 10b opposite to the surface 10a. The test pattern 12 serves to reduce the lights except for a predetermined order diffracted light, such as the 0th order diffracted light. The condensing part 14 receives collimated or substantially collimated light from a collimating part, which will be described later, and serves to condense the light. Here, the “collimated or substantially collimated light” has a filling factor a smaller than 0.1, where the filling factor is a value given by (a numerical aperture of an illumination optical system)/(a numerical aperture of a projection optical system). The lights condensed by the condensing part 14 are incident upon the test pattern 12 at different incident angles. This embodiment implements the condensing part 14 as a binary optical element (“BOE”) or diffractive optical element (“DOE”) 14a.

The illumination light of a plane wave emitted from the illumination optical system, which will be described later, passes the BOE 14a of the test reticle 10. The BOE 14a has the same effect as the lens that converts a plane wave to a spherical wave, and deflects the plane-wave illumination light to the test pattern 12. The BOE 14a in this embodiment has such a numerical aperture (“NA”) that σ>1. The BOE 14a has a focal length sufficiently longer than an optical distance between the BOE 14a and the test pattern 12 (such that the light condenses outside the test reticle 10), and illuminates the entire test pattern 12. Alternatively, the BOE 14a may have a focal length sufficiently longer than an optical distance between the BOE 14a and the test pattern 12 (such that the light condenses inside the test reticle 10), and illuminates the entire test pattern 12.

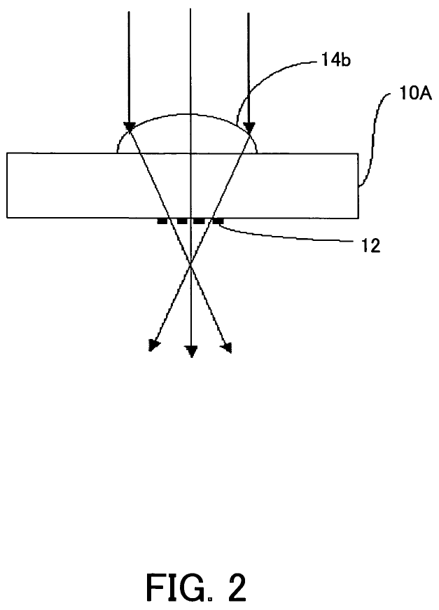

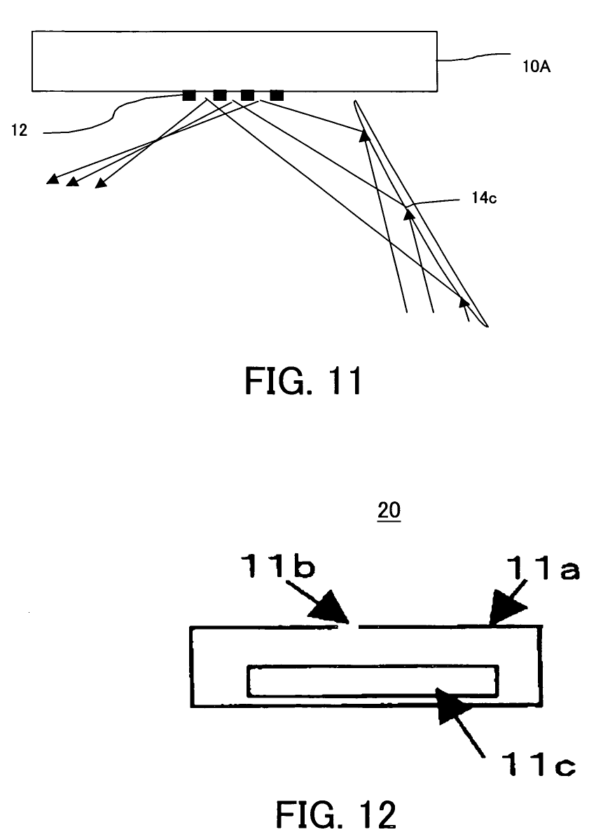

The test pattern 12 and the BOE 14a may be formed in separate plates instead of the same plate, unlike the test reticle 10. The condensing part 14 may be a lens 14b as a refractive optical element and a mirror 14c as a reflective optical element in addition to the BOE 14a. When the condensing part 14 uses the lens 14b, it may be directly adhered to the test reticle 10A as shown in FIG. 2 or may be formed on a separate plate. When the condensing part 14 uses the mirror 14c, it may be configured as shown in FIG. 11. Similar effects are available when the condensing part 14 or mirror 14c is provided in the illumination optical system or in an optical path of the illumination optical system or the test reticle 10A. Here, FIG. 2 is a schematic sectional view of the test reticle 10A as a variation of the test reticle 10. FIG. 11 is a schematic sectional view of a test reticle 10A when the condensing part 14 uses the mirror 14C.

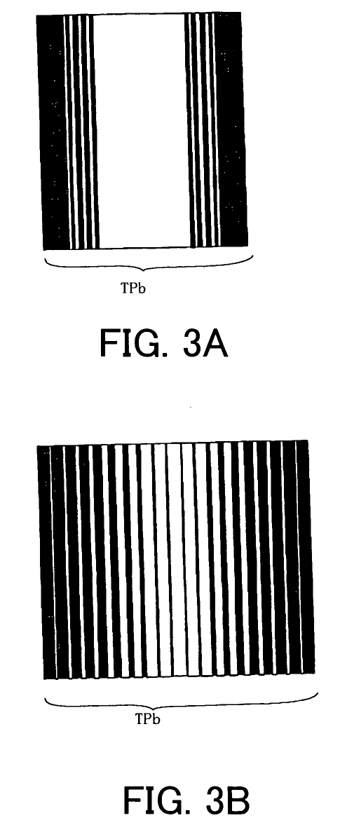

The test pattern 12 use any one of patterns shown in FIGS. 3A and 3B. The pattern has an approximately periodic pattern TPb at regular intervals between lines or spaces, and each space width that transmits the light reduces from the centerline or space to the outer pattern of the periodic pattern. An alternative pattern is one that has fine lines at both edges of a line having a certain width. These patterns are disclosed in PCT International Publication No. 03/21352. These patterns have an effect to reduce the lights except for a predetermined order diffracted light. Here, FIGS. 3A and 3B are schematic plane views of the periodic pattern TPb as a concrete example of the test pattern 12.

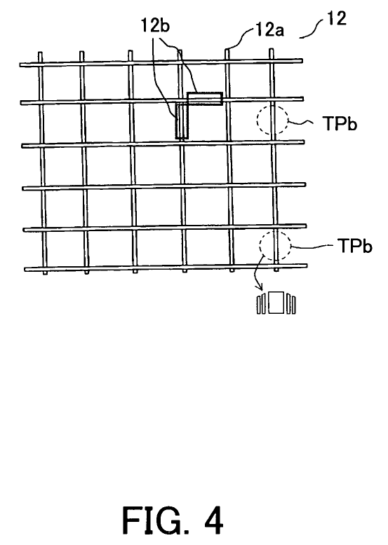

Suppose the test pattern 12 is imaged through the target optical system DOS, where the test pattern 12 has, as shown in FIG. 4, plural periodic patterns TPb shown in FIG. 3A or 3B arranged like a grating as if each periodic pattern TPb is a line. Then, the light intensity distribution of the transferred pattern image TPI can be regarded as a single pattern with such a little distortion that spaces between lines are not resolved.

FIG. 4 is a plane view showing details of the test pattern 12 formed on the test reticle 10. In FIG. 4, 12a is a mark of the test pattern 12, and each part of the grating 12b has the pattern shown in FIG. 3A or 3B. Each grating line in the mark 12a is designed to have the same width (which is 2 μm in this embodiment). Each line has the pattern shown in FIG. 3B, for example. It is preferable for the detector 20 having the pattern dependency that the width of each line is approximately equal to that of the transferred pattern image TPI on the photosensitive substrate EP, while the line of the mark 12a is not limited to that shown in FIG. 4.

The test pattern 12 may be a pattern that cancels the diffracted patterns on the pupil surface IP in the target optical system DOS, thereby reducing the high frequency components. Alternatively, the test pattern 12 may be a pattern having an opening and a periodic opening around the opening, the periodic opening generating a periodic component different from the opening on the pupil surface IP in the target optical system. Further alternatively, the test pattern 12 may be a pattern that is so shaped that no asymmetrical image distortions substantially occur even when the transferred pattern image TPI is defocused and even when the target optical system DOS has a wave front aberration.

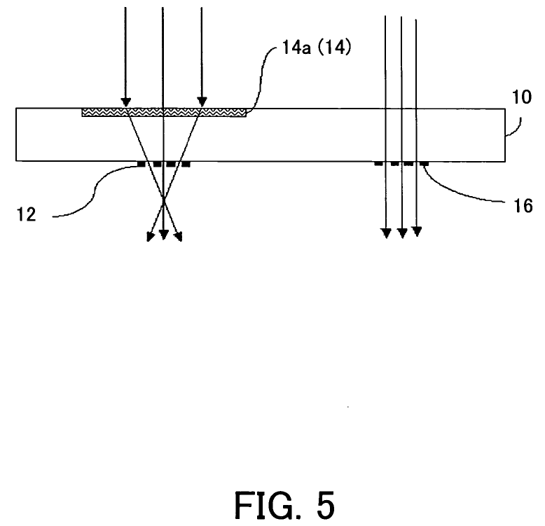

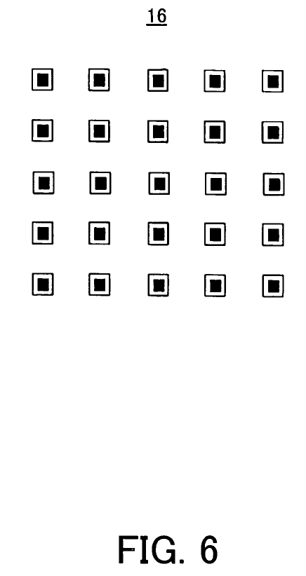

The test reticle 10 is provided, as shown in FIG. 5, with reference marks 16 for the test pattern 12. The reference marks 16 are grids used to measure a positional offset of the test pattern 12, as shown in FIG. 6. The reference marks 16 do not need condensing part 14 or BOE 14a above them unlike the test pattern 12. The illumination light from the illumination optical system is irradiated onto elements of the reference mark 16 uniformly. Here, FIG. 5 is a schematic sectional view of the entire test reticle 10 including the test reticle 12 and the reference mark 16. FIG. 6 is a plane view of the details of the reference marks 16 formed on the test reticle 10.

In measurement, the measuring apparatus 1 measures one or more aerial images or transferred pattern images TPI. A position of each aerial image or transferred pattern image TPI is determined by a line that connects the focal position of the BOE 14a above the test pattern 12 to each element in the test pattern 12. The illumination lights having different incident angles and principal rays illuminate each element in the test pattern 12. The wave front aberration of the target optical system DOS is measured by measuring one or more aerial images or transferred pattern images TPI and using the measuring method proposed in PCT International Publication No. 03/021352, which is assigned to this assignee.

For example, two illumination lights having different inclined angles and/or directions of the principal rays or the same inclined angle but symmetrical incident directions of the principal rays illuminate the test pattern 12, forming an image of the test pattern 12 or the transferred pattern image TPI through the target optical system DOS. A wave front slope on the pupil surface IP in the target optical system DOS is calculated from a positional offset amount between the images of the test pattern 12 receiving the two illumination lights within the incident surface, and the wave front aberration of the target optical system DOS is measured from the slope of the calculated wave front.

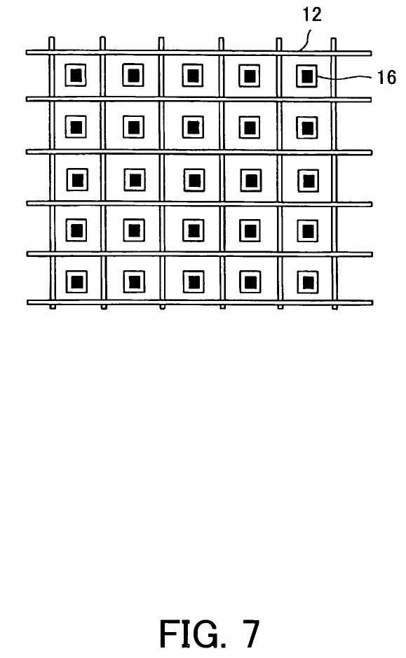

More specifically, the test reticle 10 is illuminated with that collimated or substantially collimated light by the collimating part the illumination optical system, which satisfies a small σ illumination condition (σ<0.1), and the test pattern 12 or the reference mark 16 is exposed on the photosensitive substrate EP. Next, as shown in FIG. 7, the test pattern 12 and the reference marks 16 are exposed onto the photosensitive substrate EP with the same illumination condition such that the test pattern 12 and the reference marks 16 superimpose on each other. Then, a positional offset is measured between the transferred test pattern 12 and the reference marks 16. A wave front and the wave front aberration are calculated from the obtained positional offset. When the test reticle 10 is provided with plural pairs of the test patterns 12 and the BOEs 14b, the wave front aberration can be measured for each image point of the target optical system DOS. Here, FIG. 7 is a schematic plane view showing a positional relationship between the test mark 12 and the reference marks 16 exposed on the photosensitive substrate EP.

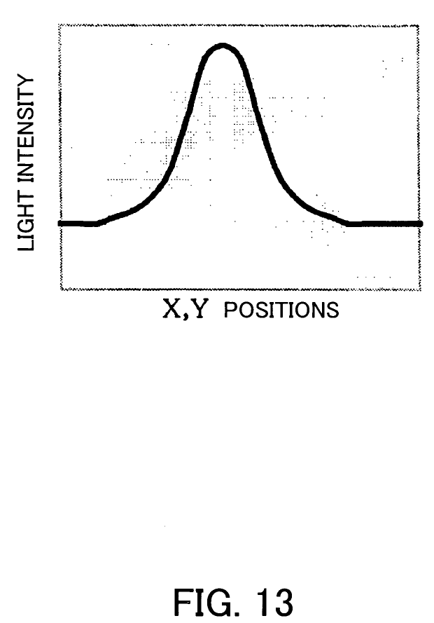

Alternatively, the detector 20 can detect a positional offset from the aerial image, and measure the wave front aberration similarly. FIG. 12 is an enlarged view of the detector 20. A slit 11b is formed in a plate 11a, and the light that has passed the slit 11b is received and detected by a light receiving part 11c. The plate 1a, the slit 11b and the light receiving part 11c in the detector 20 are placed on a wafer stage 345 that drives the photosensitive substrate EP or an object 340, which will be described later. The test pattern image TPI is imaged on the plate 11a via the projection optical system 330 as the target optical system DOS, which will be described later. The wafer stage 345 is moved so as to allow the light receiving part 11c, such as a light intensity detector or a photosensitive detector, to detect the light that transmits the slit 11b in the plate 11a. The wafer stage 345 is moved in the optical-axis direction or Z-axis direction of the projection optical system 330. Simultaneously, the wafer stage 345 is moved in the direction orthogonal to the transferred pattern image TPI within a XY plane perpendicular to the optical-axis direction. The light receiving part 11c detects the light that has passed the slit 11b in synchronization with the XY movements. A center position for one line of part 12b of the transferred pattern image TPI on the plate 11a is calculated using a detection signal that includes information of X and Y coordinate and the light intensity of the transmitting detection light at that coordinate (FIG. 13). The slit 11b is designed to have a length and width smaller than the grating pitch of the aerial image 12a as shown in FIG. 4, and is dimensioned so that the lights of the aerial image 12a except for one line does not enter the slit 11b. The slits 12b are different with respect to the longitudinal and lateral lines in FIG. 4. Each may have a different light receiving part 11c and they may be switched whenever the longitudinal and lateral lines 12a to be measured switch. Then, the wafer stage 345 is moved near the next position of the line image 12a, and the center position of each of the longitudinal and lateral lines is sequentially and similarly measured over the pupil area. The wave front aberration of the projection lens is finally calculated from the wave front slope. The actual measuring method is the same as that proposed in PCT International Publication No. 03/021352 by this assignee, and a detailed description thereof will be omitted.

The measuring apparatus 1 can maintain the light intensity and measure the wave front aberration of the target optical system more accurately than the conventional one, because the condensing part 14 does not block the illumination light or the measuring apparatus 1 uses no pinhole. In addition, in measuring the wave front aberration by exposing the test pattern 12 and reference marks 16 onto the photosensitive substrate EP, the same light intensity can be maintained as that at the exposure time. Therefore, the measuring time can be shortened and does not delay the exposure time.

While the measuring apparatus 1 of this embodiment is used to measure the optical characteristic of any of dioptric, catoptric and catadioptric projection optical systems.

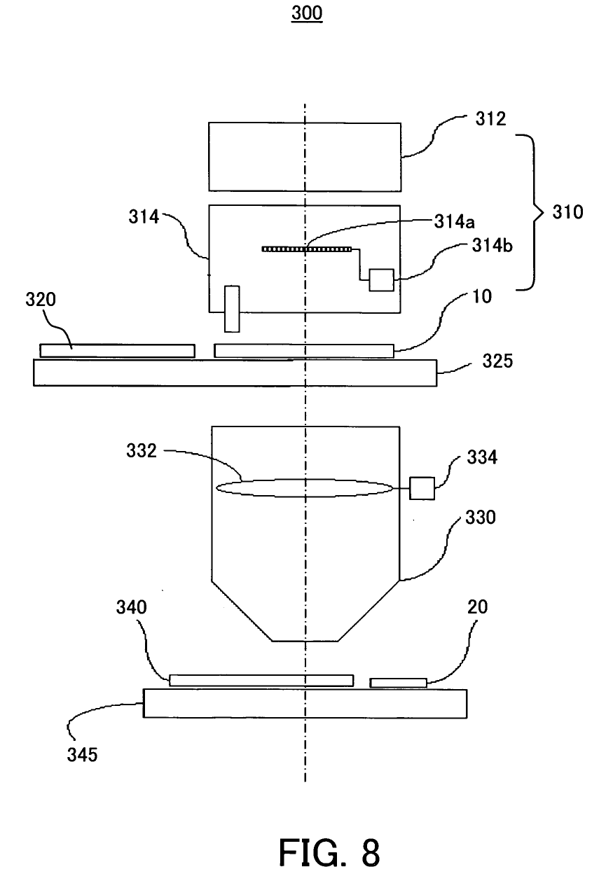

A description will now be given of the exposure apparatus 300 that includes the measurement method 1 and/or test reticle 10. Here, FIG. 8 is a schematic sectional view of the exposure apparatus 300 as one aspect according to the present invention. The exposure apparatus 300 includes an illumination apparatus 310 that is different from or integrated with the measuring apparatus 1, a reticle 320 which has a circuit pattern of a semiconductor device, such as a semiconductor chip (e.g., IC and LSI), a liquid crystal panel and a CCD, and the test reticle 10. The exposure apparatus 300 exposes a circuit pattern of the reticle 320 onto an object 340, for example, in a step-and-scan manner. Although the inventive exposure apparatus is not limited to a scanner, if it is applied, it can quickly and accurately measure and correct the optical characteristic of the projection optical system 330.

The illumination apparatus 310 illuminates the test pattern 12 and the reticle 320 that has a circuit pattern to be transferred, and includes a light source unit 312 and an illumination optical system 314.

As an example, the light source unit 312 uses a light source such as an ArF excimer laser with a wavelength of approximately 193 nm and a KrF excimer laser with a wavelength of approximately 248 nm. However, the laser type is not limited to excimer lasers and, for example, F₂ laser with a wavelength of approximately 157 nm and a YAG laser may be used. Similarly, the number of light sources is not limited. For example, two independently acting solid lasers would cause no coherence between these solid lasers and significantly reduces speckles resulting from the coherence. An optical system for reducing speckles may swing linearly or rotationally. When the light source unit 312 uses laser, it is desirable to employ a beam shaping optical system that shapes a parallel beam from a laser source to a desired beam shape, and an incoherently turning optical system that turns a coherent laser beam into an incoherent one. A light source applicable for the light source unit 312 is not limited to a laser, and may use one or more lamps such as a mercury lamp and a xenon lamp.

The illumination optical system 314 is an optical system that illuminates the test reticle 10 and the reticle 320, and includes a lens, a mirror, a light integrator, a stop, and the like, for example, a condenser lens, a fly-eye lens, an aperture stop, a condenser lens, a slit, and an imaging optical system in this order. The illumination optical system 314 can use any light regardless of whether it is axial or non-axial light. The light integrator may include a fly-eye lens or an integrator formed by stacking two sets of cylindrical lens array plates (or lenticular lenses), and can be replaced with an optical rod or a DOE.

In this embodiment, the illumination light emitted from the light source unit 312 meets a small a illumination condition, i.e., an illumination condition with σ<0.1 for illuminating the test reticle 10 with the collimated light or substantially collimated light. In other words, the collimating part of the present invention corresponds to the illumination optical system 314 in this embodiment. The illumination optical system 314 in this embodiment has a stop 314a driven by a drive system 314b. The stop 314a is an iris type that can easily form differently sized illumination conditions or is a type that switches among various shapes. σ<0.1 is realized by making small the opening of the stop 314a.

The reticle 320 is made, for example, of quartz, has a circuit pattern to be transferred, and is supported and driven by a reticle stage 325. The diffracted light emitted from the reticle 320 passes the projection optical system 330 and is then projected onto the object 340. The reticle 320 and the object 340 are located in an optically conjugate relationship. Since the exposure apparatus 300 is a scanner, the reticle 320 and the object 340 are scanned at the speed ratio of the reduction ratio of the projection optical system 330, thus transferring the pattern of the reticle 320 onto the object 340. If it is a step-and-repeat exposure apparatus (referred to as a “stepper”), the reticle 320 and the object 340 remain still during exposure.

The test reticle 10 is used to measure the wave front aberration of the projection optical system 330, and is supported and driven by the reticle stage 325. The test reticle 10 may use any of the above types, and a detailed description will be omitted.

The reticle stage 325 supports the reticle 320 and the test reticle 10 via reticle chucks (not shown), and is connected to a moving mechanism (not shown). The moving mechanism (not shown) includes a linear motor, etc., drives the reticle stage 325 in the X-axis direction, and moves the reticle 320 and the test reticle 10.

The projection optical system 330 serves to image the diffracted light from the pattern of the reticle 320 onto the object 340. The projection optical system 330 may use a dioptric optical system comprising solely of a plurality of lens elements, a catadioptric optical system including a plurality of lens elements and at least one concave mirror (a catadioptric optical system), an optical system including a plurality of lens elements and at least one DOE such as a kinoform, a full mirror type or catoptric optical system, and so on. Any necessary correction of the chromatic aberration may be accomplished by using a plurality of lens units made from glass materials having different dispersion values (Abbe values) or arranging a DOE such that it disperses light in a direction opposite to that of the lens unit.

The projection optical system 330 has a correction optical system 332 in this embodiment. The aberration of the projection optical system 330 can be corrected by feeding back the wave front aberration measured by using the test reticle 10 (measuring apparatus 1) to the projection optical system 330. More specifically, the correction optical system 332 allows plural optical elements (not shown) to move in the optical-axis direction and/or a direction orthogonal to the optical-axis direction. By driving one or more optical elements using a driving system (not shown) for aberrational adjustments based on aberrational information obtained from this embodiment, it is possible to correct or optimize the wave front aberration of the projection optical system 330. The aberration adjusting means for the projection optical system 330 can use various known systems, such as a movable mirror (when the projection optical system is a catadioptric or catoptric optical system), an inclinable plane-parallel plate, a pressure-controllable space, and a surface correction using an actuator, as well as a movable lenses.

The object 340 is supported and driven by a wafer stage 345. The object 340 is a wafer in this embodiment, but broadly covers a liquid crystal substrate and other objects to be exposed. Photoresist is applied to the object 340.

The wafer stage 345 supports the object 340. The stage 345 may use any structure known in the art, thus, a detailed description of its structure and operation is omitted. The stage 345 may use, for example, a linear motor to move the object 340 in the XY directions. The reticle 320 and object 340 are, for example, scanned synchronously, and the positions of the stage 345 and a reticle stage 325 are monitored, for example, by a laser interferometer and the like, so that both are driven at a constant speed ratio. The stage 345 is installed on a stage stool supported on the floor and the like, for example, via a dampener. The reticle stage 325 and the projection optical system 330 are installed on a barrel stool (not shown) that is supported, for example, via a dampener, by the base frame placed on the floor.

In exposure, light is emitted from the light source unit 312, e.g., Koehler-illuminates the reticle 320 via the illumination optical system 314. The light that passes through the reticle 320 and reflects the reticle pattern is imaged onto the object 340 by the projection optical system 330. The wave front aberration of the projection optical system 330 has been corrected or optimized in the exposure apparatus 300. The exposure apparatus 300 provides high-quality devices (such as semiconductor devices, LCD devices, photographing devices (such as CCDs, etc.), thin film magnetic heads, and the like) with high throughput and economic efficiency since it suppresses a distortion to the utmost limit while transmitting the UV light, FUV light, and VUV light at a high transmittance. The wave front aberration of the projection optical system 330 is measured with no pinhole, and the test pattern 12 and the reference mark 16 can be exposed only by a single scan exposure. Therefore, the measuring time period becomes shorter than the conventional one that requires plural scan exposure. The measuring accuracy does not deteriorate due to the alignment error, and the wave front aberration of the projection optical system 330 can be accurately measured and corrected.

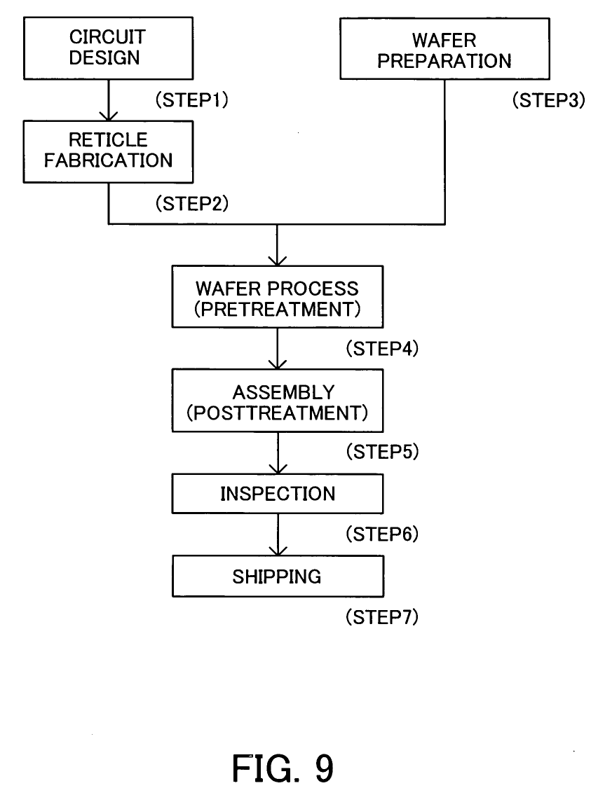

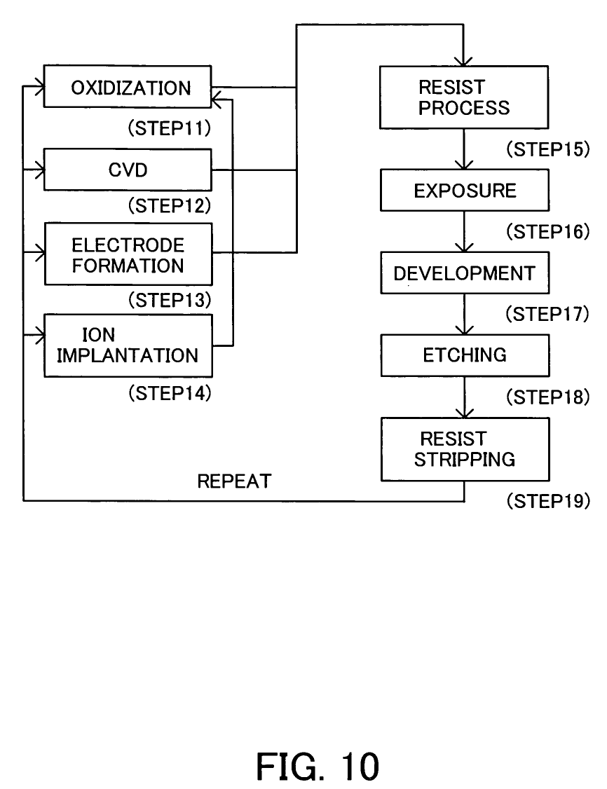

Referring now to FIGS. 9 and 10, a description will now be given of an embodiment of a device manufacturing method using the above projection exposure apparatus 300. FIG. 9 is a flowchart for explaining a fabrication of devices (i.e., semiconductor chips such as IC and LSI, LCDs, CCDs, etc.). Here, a description will be given of a fabrication of a semiconductor chip as an example. Step 1 (circuit design) designs a device circuit. Step 2 (mask fabrication) forms a mask having a designed circuit pattern. Step 3 (wafer preparation) manufactures a wafer using materials such as silicon. Step 4 (wafer process), which is referred to as a pretreatment, forms actual circuitry on the wafer through the photolithography using the mask and wafer. Step 5 (assembly), which is also referred to as a posttreatment, forms into a semiconductor chip the wafer formed in Step 4 and includes an assembly step (e.g., dicing, bonding), a packaging step (chip sealing), and the like. Step 6 (inspection) performs various tests for the semiconductor device made in Step 5, such as a validity test and a durability test. Through these steps, a semiconductor device is finished and shipped (Step 7).

FIG. 10 is a detailed flowchart of the wafer process in Step 4. Step 11 (oxidation) oxidizes the wafer's surface. Step 12 (CVD) forms an insulating film on the wafer's surface. Step 13 (electrode formation) forms electrodes on the wafer by vapor disposition and the like. Step 14 (ion implantation) implants ions into the wafer. Step 15 (resist process) applies a photosensitive material onto the wafer. Step 16 (exposure) uses the exposure apparatus 300 to expose a mask pattern onto the wafer. Step 17 (development) develops the exposed wafer. Step 18 (etching) etches parts other than a developed resist image. Step 19 (resist stripping) removes disused resist after etching. These steps are repeated, and form multilayer circuit patterns on the wafer. The device manufacturing method can manufacture higher quality devices than the conventional. Thus, the device manufacturing method that uses the exposure apparatus 300, and its resultant products also constitute one aspect of the present invention.

Further, the present invention is not limited to these preferred embodiments, and various variations and modifications may be made without departing from the scope of the present invention.

This application claims a foreign priority based on Japanese Patent Application No. 2004-265482, filed Sep. 13, 2004, which is hereby incorporated by reference herein.

What is claimed is:

1. A measuring apparatus for measuring optical characteristic of a target optical system, said measuring apparatus comprising:
plural patterns for reducing diffracted lights except for a predetermined order diffracted light;
a collimating part for producing collimated or substantially collimating light; and
a condensing part for condensing the collimated or substantially collimated light so that lights having different angles are incident upon the plural patterns,
wherein the predetermined order diffracted lights emitted from the plural patterns enter pupil surface in the target optical system at different positions.

2. A measuring apparatus according to claim 1, further comprising a test reticle that includes said condensing part on one surface thereof, and said plural patterns on the other surface thereof opposite to the one surface.

3. A measuring apparatus according to claim 1, wherein the predetermined order diffracted light is 0th order light.

4. A measuring apparatus according to claim 1, wherein said condensing part includes a diffractive optical element.

5. A measuring apparatus according to claim 1, wherein said condensing part includes a reflective optical element.

6. A measuring apparatus according to claim 1, wherein said condensing part includes a refractive optical element.

7. A measuring apparatus according to claim 1, wherein the collimated or substantially collimated light has a filling factor a smaller than 0.1.

8. A measuring apparatus according to claim 1, wherein a condensing position which condensed by said condensing part is away from and at a light exit side of the plural patterns.

9. A test reticle used to measure optical characteristic of a target optical system, said test reticle comprising:
plural patterns, formed on one surface, for reducing diffracted lights except for a predetermined order diffracted light; and
a condensing part for condensing light so that lights having different angles are incident upon the plural patterns.

10. An exposure apparatus for exposing a pattern of a reticle onto a substrate, said exposure apparatus comprising:
a projection optical system for projecting the pattern onto the substrate; and
a measuring apparatus according to claim 1 for measuring optical characteristic of said projection optical system.

11. An exposure apparatus according to claim 10, further comprising a modification part for changing the optical characteristic of said projection optical system based on a measurement result by said measuring apparatus.

12. An exposure apparatus for exposing a pattern of a reticle onto a substrate, said exposure apparatus comprising:
a projection optical system for projecting the pattern onto the substrate; and
a test reticle according to claim 9 adapted to be inserted into and ejected from an optical path of said exposure apparatus.

13. A device manufacturing method comprising the steps of:
exposing an object using an exposure apparatus according to claim 10; and
developing the object exposed.

14. A device manufacturing method comprising the steps of:
exposing a substrate using an exposure apparatus according to claim 12; and
developing the substrate exposed.

15. A measuring apparatus for measuring optical characteristic of a target optical system, said measuring apparatus comprising:
a patterned member having a pattern for optically reducing diffracted light to be supplied to a pupil in the target optical system; and
a condensing part for condensing collimated or substantially collimating light to be incident upon said patterned member so that the pattern receives the light having different incident angles.
